(19) United States
(12) Patent Application Publication
(10) Pub. No.: US 2002/0078016 A1
(43) Pub. Date: Jun. 20, 2002

(54) Integrated lab management system and product identification system

(76) Inventors: Erik K. Lium, Belmont, CA (US); David C. Balducci, San Francisco, CA (US)

Correspondence Address: Pillsbury Winthrop LLP, Intellectual Property Group, Calendar/Docket Department, 50 Fremont Street, San Francisco, CA, 94105, US

(21) Appl. No.: 09/910,487

(22) Filed: Jul. 20, 2001

Related U.S. Application Data
(60) Provisional application No. 60/219,488, filed on Jul. 20, 2000.
(60) Provisional application No. 60/219,487, filed on Jul. 20, 2000.
(60) Provisional application No. 60/219,486, filed on Jul. 20, 2000.

(51) Int. Cl. G06F 7/00

(52) U.S. Cl. 707/1

(57) ABSTRACT

The invention provides a system and process for integrating hierarchical searching with parametric searching at each level of the hierarchy depending on the intended use. Specifically, the invention provides a system and method for inputting or selecting a product or compound name; determining one or more uses of the product or compound and displaying a list of such use or uses; selecting a use of the product; generating a parameter selection site based on the selected use; inputting parameters; and generating a list of products that meet the selected parameters. The product or compound name can be selected at any level in the hierarchy. For example, the name can be selected at the products leaf or within the products ontology. The database of products and compounds is virtually limitless in that additional products may always be added to the database.

This application claims the benefit of U.S. Provisional Application Nos. 60/219,488, 60/219,487, and 60/219,486, all of which were filed on Jul. 20, 2000, and the contents of each of which are incorporated herein by reference.

This disclosure may contain material that is subject to copyright protection. The copyright owner has no objection to the facsimile reproduction by anyone of the patent document or patent disclosure as it appears in the United States Patent and Trademark Office patent files or records, but otherwise reserves all copyright rights whatsoever.

### BACKGROUND

Many industries require a high degree of specialization of products and information. The life science industry is one such example. Due to this specialization, scientists are overburdened with many catalogs and other information resources from thousands of suppliers research products including, but not limited to, research reagents, equipment and scientific publications. Scientists most commonly manage the overabundance of choice by seeking recommendations from colleagues, and/or searching manually searching catalogs or other publications for technical information. These approaches, however, fail to tap the increasingly large amount of information available in the market, and result in useful products from related suppliers being overlooked and under utilized.

As the medium for information has shifted to the Internet, individual suppliers are developing progressively more functional web sites to allow their customers to find information about their products. While scientists do use these sites for technical information and protocols related to their specific products, these sites are disadvantageous to the scientists for several reasons. First, the scientist must be familiar with or know the name of the manufacturer or supplier in order to access their site. Second, the scientist cannot compare equivalent products or protocols or techniques from other suppliers on a single suppliers web site, and thus, cannot make fully educated purchasing decisions. Third, suppliers may limit access to their websites.

Some life science businesses have produced e-commerce sites to tap the need for a one-stop shopping option; however, these companies have not approached the presentation of product information from a user's perspective, have limited options for functional product comparisons, and have not integrated their services with other information services. Examples of such businesses include, Fisher Scientific, VWR, SciQuest, Chemdex, Anderson Webalog and Biocompare. These web sites are tedious to use, and produce lists of products that often contain hundreds of items. Thus, these lists do not provide functionally relevant or practical information, and ultimately, result in unproductive searches. In other words, these sites force the scientist, or any other user, to know the name of a product in order to identify that product within their system. Additionally, many of the web sites employ simple, non-specific, field searching tools.

Other search systems include a hierarchical categorization. Hierarchical categorization with highly visible levels of product organization allow for the fewest clicks to a product family. Sites such as Yahoo! use hierarchical categorization. Two patents related to hierarchical organization in the context of searching are U.S. Pat. Nos. 5,799,301 and 5,842,203.

Yet other search systems use a parametric approach for searching. Companies that use this approach include, for example, Sears, Maxim, Saqqara and Point.com, as well as a number of computer sites.

Other services that scientists use include traditional and on-line protocol collections. Scientific protocols, or methods, are the recipes that scientists use to perform their experiments. Due to the difficult nature of adapting an existing experimental approach to a new problem, scientists focus their attention on well-established protocols that will enable them to execute an experiment successfully. Due to the expense of published collections of protocols that laboratories may purchase, an on-line resource of aggregated, freely available protocols is a great benefit to scientists. Several online protocol collections have been published, such as those in DoubleTwist, Metazoa, Bioprotocol and as aggregated in BioTaq. However, many of these providers solicit and publish protocols directly for scientists. While this approach is inexpensive, it lacks significant editorial review. In addition, these sites do not link relevant products and protocols within a purchasing resource, though examples of this service can be found in other fields. For example, in the food industry, Webvan.com links recipes for cooking to grocery lists. Some of these grocery lists are linked directly to products, but as this is a site that sells its products directly, users may only select from Webvan.com products. Accordingly, there are no price comparison options.

Therefore, there exists a need for a system that emphasizes cognitive organization, ease of use, directed parametric searches and product comparison at the level of function. This system must not only integrate all available search options including hierarchical organization and parametric searches, but also integrate resources and tools used by an individual in the industry being served, for example a scientist. In addition, there is a need for a system for product searches based on user-directed input which in turn, gives the user the ability to rapidly identify those products that best serve their research requirements based solely on the knowledge of those requirements.

### SUMMARY OF THE INVENTION

The invention relates to a system for integrating many search options with the necessary resources and tools in the field to enable a user to identify a product, protocol or other tool in conjunction with other resources in the field. The invention accomplishes this by positioning a system for hierarchical organization over many parametric search tools, and integrating this system with the resources, tools, literature, and products in the field. The invention also provides a search system for the identification of items within the hierarchical organization, thereby providing a range of broad to narrow search results, comparison tables and linking or integration of diverse resources and information sets such as protocols, literature, tools, tables and other resources, with products.

One embodiment of the invention provides a method for obtaining a list of products having specified parameters, wherein the method comprises having a user input a product or compound name; communicating the name to an analysis program which determines one or more uses of the product or compound and displaying a list of such use or uses; having a user select a use of the product; communicating the selected use to the analysis program to generate a parameter selection site based on the selected use; having the user input parameters; and communicating the selected parameters to the analysis program to generate a list of products that meet the selected parameters.

### BRIEF DESCRIPTION OF THE DRAWINGS

FIG. 1 is a block-diagram illustrating a computer 100 in accordance with the present invention.

FIG. 2 is a flowchart of the program steps when displaying a home or leaf page.

FIG. 3 displays the Home Page with leaves directed to Products, Protocols, Tools, Tables, Literature and News.

FIG. 4 shows an example of the display when the user selects the Products leaf.

FIG. 5 is a flowchart of the steps a user may take to select a desired product from the site.

FIG. 6 is a flowchart illustrating the integration of hierarchical searching with parametric searching at each level of the hierarchy.

FIG. 7 shows an example of the display when the user selects the Protocol leaf.

FIG. 8 is a flowchart of the steps a user may take to select a specific protocol from the site.

FIG. 9 shows an example of the display when the user selects the Literature leaf.

FIG. 10 shows an example of the display when the user selects the Tools leaf.

FIG. 11 shows an example of the display when the user selects the Tables leaf.

FIG. 12 shows an example of the display when the user selects the News leaf.

FIGS. 13a-c provides flowcharts for examples of the integration between levels.

### DETAILED DESCRIPTION

The invention provides a system for integrating a variety of search options with the necessary resources and tools in the field. Specifically, the invention allows for individuals in many fields, including biotechnology, chemistry, physics, agriculture, etc., to rapidly find products they need to perform their work. The product search process may involve one or more steps including: a) finding a specific product by keyword or catalog number searches; b) searching for products based on pre-determined attribute; or c) exploring product offerings by examining novel combinations of product attributes. The invention accomplishes this by positioning of a hierarchical organization over parametric search tools and integrating this system with the resources, tools, literature, and products in the field. The invention comprises applications including: an ontology and product record creation and management tool; a protocol management tool; a tools and tables management tool; a news management tool; a relationship/association creation and management tool; and a business unit management tool. The invention also provides a search system for searching within the hierarchical organization, thereby providing a range of broad to narrow search results. Additionally the invention provides a system where a product may be identified in the absence of a manufacture name, using scientific needs as a basis for searching.

As shown in FIG. 1, computer 100 includes a memory 110 that has an operating system block that stores an operating system, a program instruction block that stores program instructions, and a data block that stores data. The operating system can be implemented with, for example, the Microsoft 2000 Server operating system, although other operating systems such as Solaris or Linux can alternately be used. The program instructions can be written, for example, in C++ although other languages can alternately be used.

As further shown in FIG. 1, computer 100 also includes a central processing unit (CPU) 112 that is connected to memory 110. CPU 112, which can be implemented with, for example, a Pentium processor, processes information in response to the program instructions and the data. Although only one processor is described, the present invention can be implemented with multiple processors in parallel to increase the capacity to process large amounts of information.

Further, computer 100 includes a memory access device 114, such as a disk drive or a networking card, which is connected to memory 110 and CPU 112. Memory access device 114 allows the program instructions to be transferred to memory 110 from an external medium, such as a disk or a networked computer.

Computer 100 further includes a display system 116 that is connected to CPU 112. Display system 116 displays images to the user, which are necessary for the user to interact with the program. Computer 100 also includes a user-input device 118, such as a keyboard and a pointing device, which is connected to CPU 112. The user operates input device 118 to interact with the program.

Although a single local computer 100 is shown in FIG. 1, it should be noted that a plurality of local computers may be connected with the system, wherein each computer 100 is situated in a location of the user, for example, a lab. Any type of computer may serve as the computer 100. Examples of computer 100 include, but are not limited to, a personal computer, a workstation, a server, and a super-computer. Other computer system configurations may also be used, such as hand-held devices, microprocessor-based or programmable consumer-electronics, network PCs, and the like. If a plurality of local computers are used, for example at a research institution or university, the local computer can be capable of communicating with other computers or servers via one or more communication routes such as telephone or cable lines, local area network (LAN) and wide area network (WAN) links, and wireless networks.

Initially, and as shown in FIG. 2, the invention employs a program which displays Home Page 200. When the user selects a leaf 201, the program will display the selected leaf 202.

As illustrated in FIG. 3, the invention provides a searchable database of scientific products from a fragmented market of suppliers via a Home Page 200. After the site has been loaded and running, computer 100 displays Home Page 200 with leaves directed to Products 210, Protocols 220, Tools 230, Tables 240, Literature 250 and News 260. By clicking on Products leaf 210, the user can view a listing of various products groups and subgroups. Products are stored with core product information and additional product-specific information that is used in advanced searches and at the product comparison level. Products are found in the database, either through traditional keyword searching or by proprietary advanced searching techniques. The products are displayed in a format, preferably a table format, which allows the scientist to compare similar products and make an informed purchasing decision. The products in the database can be found by traditional keyword searches such as product name and catalog number. For example, the user can either enter a product name or company name and search all products under that company. Alternatively, the user can enter a company name and a catalog number. However, if the user does not know the specific company or wants to search a group of products, the user can click onto one of the subgroups that most closely identifies with the field of choice. These product groups are generally a tree search and serves as a form of a guided or hierarchical search. This method offers a list of product groups from which to select. This form allows the user to narrow down to a subset of items from which to select.

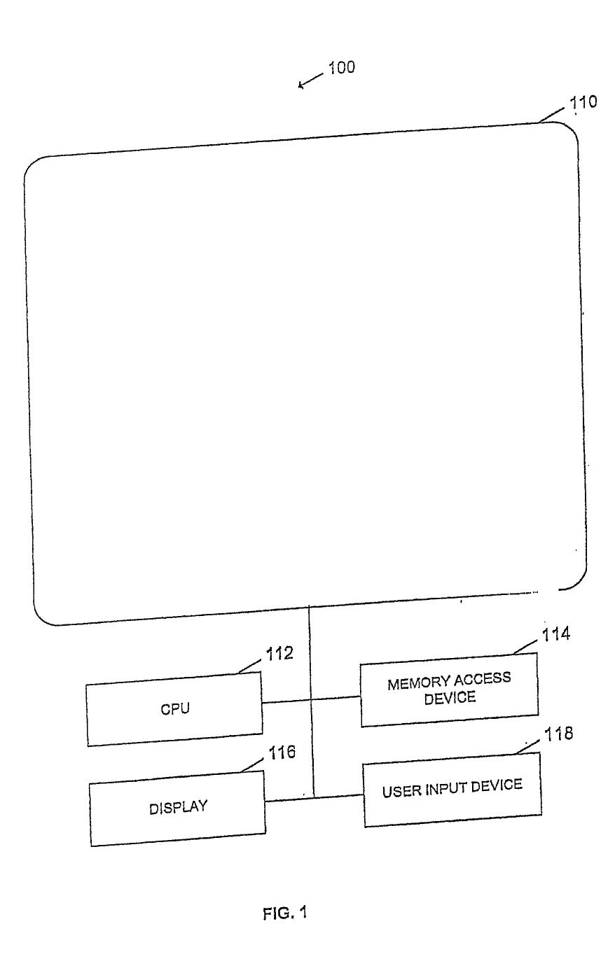

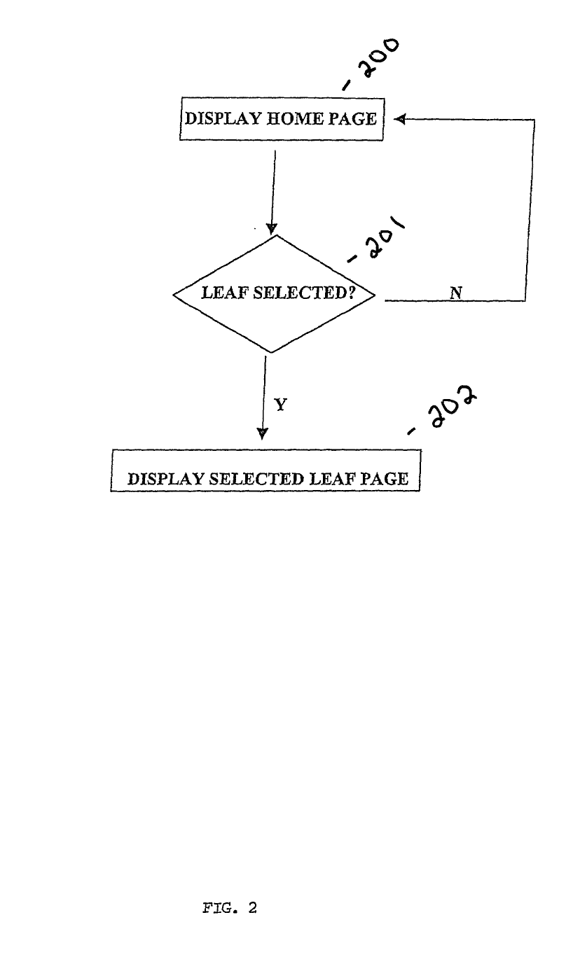

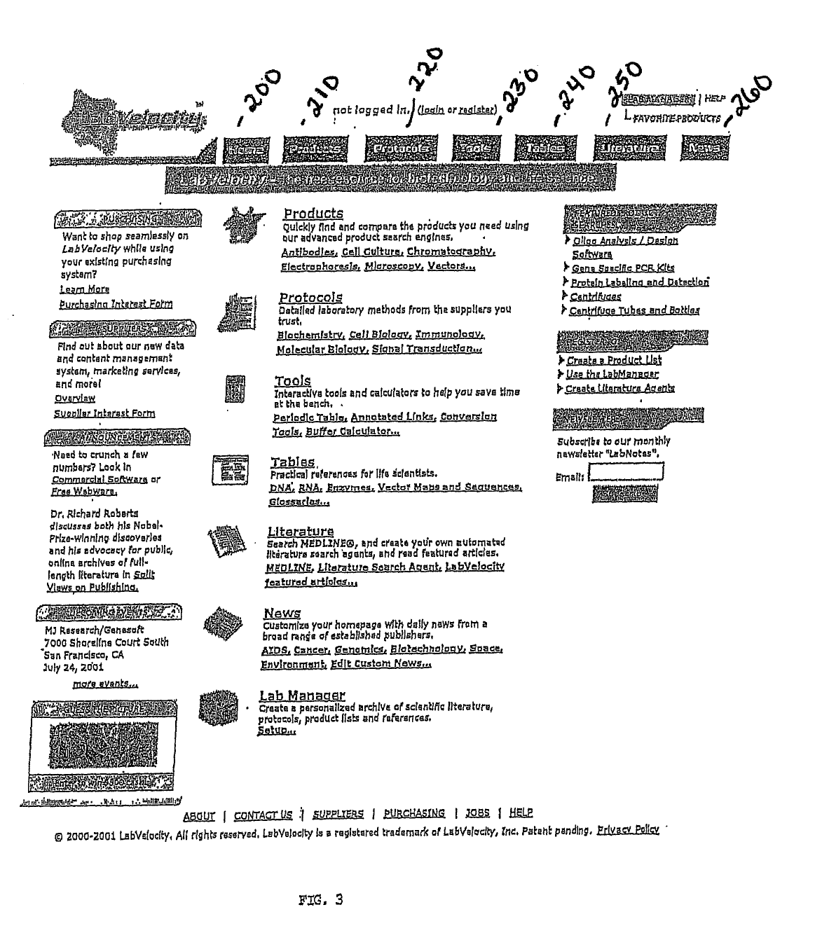

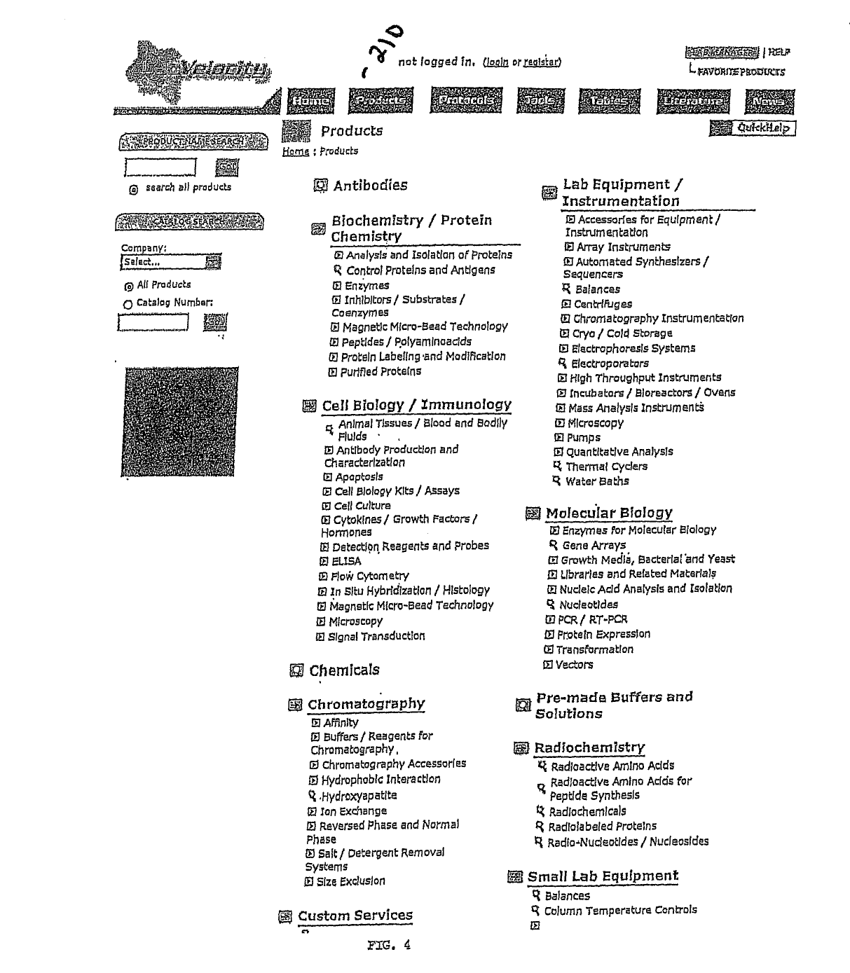

The database is constructed as a novel product ontology, or a hierarchical layout of scientific products. FIG. 4 shows an example of a product categorization site displayed when the user selected Products leaf 210 from Home Page 200. The ontology portion of the application provides all major functionalities to create categories and leaves within an ontology or systematic hierarchical organization structure. It may also assign parameters and corresponding values to specific or non-specific leaves in the ontology. The product portion of the application provides all functionalities required for the entry or placement of digital product records of diverse data types into the ontology; addition of specialized data sets or parameters to digital records to facilitate parametric searching and organization; and loading of product records into production databases.

Using domain specific knowledge of the life science research arena, a cohesive and intuitive hierarchy as embodied in the invention allows placement of product families from a diverse group of suppliers into one unifying layout. The detailed hierarchy, or ontology, consists of major headings with subcategories. The headings can include a variety of life science disciplines, for example, molecular biology and cell biology, etc. In addition, the invention provides for major experimental areas, for example, chromotography and electrophoresis. Layers of subcategories below the major headings are designed in a manner that allows the end-user to navigate with an increasing degree of assurance that they will find the product they are seeking. The end of the hierarchy is reached at the product family level when further sub-categorization is non-intuitive. Finding products from advanced searches or product listings occurs at this level. The product ontology allows the user to quickly find pertinent product families containing products relevant to their purchasing needs with a minimum number of “click-throughs,” for example two or three clicks.

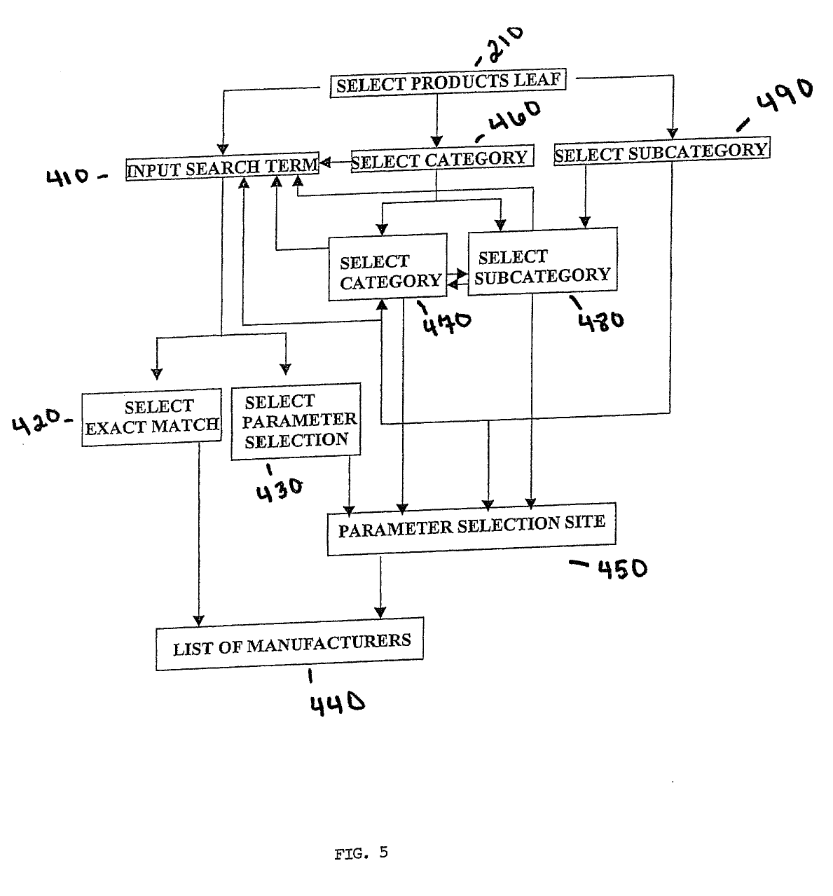

The invention also provides for a novel means for advanced parametric searches. The narrowing down of product offerings at the product family level is achieved by user-directed searching from a predefined field of product features or parameters. Relevant parameters are defined for each product family based upon product-specific domain knowledge. User-selected values for one or more of the parameters are used as the search criteria. Products within the family that meet the requested criteria are displayed. The user can further refine the search process or explore one or more of the scientific products in more detail. For example, on the general product page, the user can click onto the “Cell Culture” link. From there, the user has a choice of subcategories and may choose, for example, the “Flasks” link. The next page is then a parameter-input page where the user may enter a manufacturer, surface treatment, approximate culture area and filter cap. The user may choose to enter specifics in all of these fields or choose at least one of them. After clicking on the desired parameters, the user then clicks on “OK” and is taken to a list of “Search Results.” FIG. 5 shows a flowchart of the steps a user may take to select a desired product from the site.

As shown in FIG. 5, when the user selects the Products leaf 210 from Home Page 200, the user can then choose from at least three different options to find a desired product. If the user knows the product or compound name, the user may input a search term 410. Upon entering a search term, the user may then choose to select an Exact Match 420 or Parameter Selection 430. If the user selects the Exact Match 420, a list of manufacturers 440 is displayed. If the user instead selects Parameter Selection 430, the user is then taken to a Parameter Selection Site 450. Upon entering the desired parameters, a list of manufacturers 440 is displayed.

Alternatively, the user may select a category 460 from the Products leaf 210. After selecting the category, the user may select another narrower category 470 or a specific subcategory 480. At any point, the user may enter a search term 410 and follow the process outlined above. It is important to note that the search will yield a product selection depending at what point, i.e. what level of the category/subcategory hierarchy, the user inputs the search term. In addition, within each category level there may be several categories and subcategories. When further breaking down of categories and subcategories becomes nonintuitive, the user is taken to parameter selection site 450. The user may also select a subcategory 490 from the main products leaf page. Again, the subcategory can be further divided or lead directly to a parameter selection site. In addition, the user may input a search term at this or any level of the search process.

Once a search has been performed, a list of products that match the search criteria is displayed. A refined search can be performed to change the members of the list by altering the selected parameter. Selecting members of the list for further comparison generates a comparison table with all selected products that meet the defined criteria and the values for the relevant features displayed. This comparison table is used to make purchasing decisions among the displayed products.

Products selected from the comparison table are placed on a shopping list. This shopping list can be e-mailed to a purchasing agent, directly to a supplier, or printed out for the scientist to use to fill out purchasing orders.

One embodiment of the invention includes a product agent that stores information about products in which its users are interested. The agent serves many purposes. The user may select to relay the request for products to the supplier on a periodic basis. This would ensure that the user would keep a constant supply of an often-used item. In addition, if the user inputs parameters of a product that is non-existent at that time, the agent will store this information and when the specified product becomes available or is added to the database, the user will be notified.

Queries entered into the product agent will be responded to using a tracking system. The queries are stored and the data mined to identify new sets of parameters that define new products. This system tracks the product information and when the product is found, an email stating such is sent to the user.

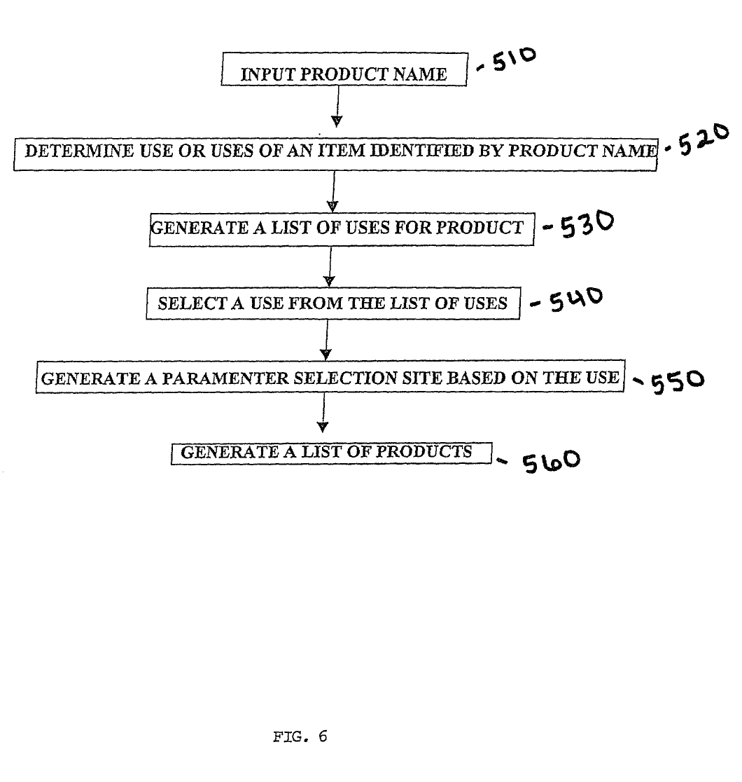

A preferred embodiment of the invention is the integration of hierarchical searching with parametric searching at each level of the hierarchy depending on the intended use. As shown in FIG. 6, the invention provides a system and method for inputting or selecting a product or compound name 510; determining one or more uses of the product or compound 520 and displaying a list of such use or uses 530; selecting a use of the product 540; generating a parameter selection site based on the selected use 550; inputting parameters; and generating a list of products that meet the selected parameters 560. The product or compound name can be selected at any level in the hierarchy. For example, the name can be selected at the products leaf or within the products ontology. The database of products and compounds is virtually limitless in that additional products may always be added to the database.

The analysis program as used in the invention is any program that allows the user to select a product and be provided a parameter selection site depending on what point in the hierarchy the product was selected. For example, a product name entered on the products leaf page will yield a list of various uses for that product from which the user may select. Upon selection the user may be required to make a further selection of product uses and so on until the parameter selection site for that intended use is displayed.

The analysis program is based on information attributed to each compound or product name at each level. The program includes logic that provides either the next level of differentiation or when the use is determined such that further sub-categorization is non-intuitive, the program displays a parameter selection page. The user may then input some, all or even no parameters to obtain a list of manufacturers that produce a product for the user's desired use. For example, when the user inputs a product name, the name is communicated to the program. The program then generates a list of uses for that product, wherein the list is narrowed at each level of the product ontology. The user then may select a product use or if there is only one use of the product, the user may input desired parameters for the intended use. The user-input information is then communicated to the program and a list of manufacturers that sell the product with the desired parameters is displayed. The program preferably includes logic that takes the user's request that one or more products be ordered and electronically orders the products for the user.

Protocols

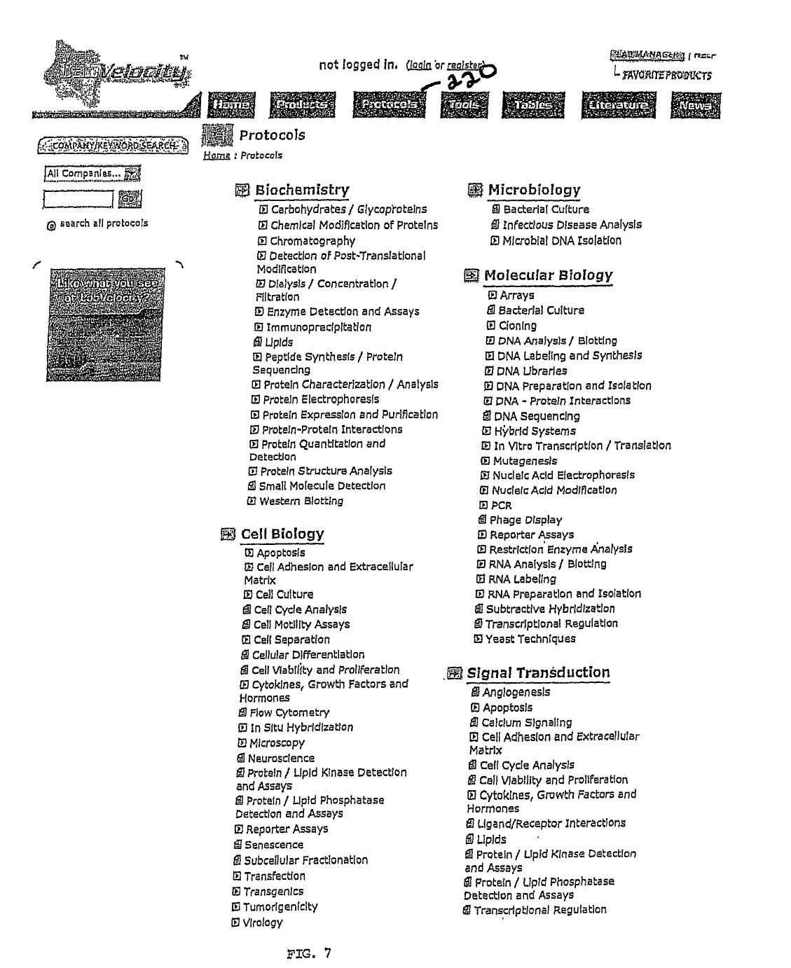

In addition to providing a product database, another embodiment of the invention provides a variety of protocols within the major headings and subheadings in a field, for example, life sciences. FIG. 7 shows an example of the display on computer 100 when the user selects Protocol leaf 220. This embodiment provides an approach to directly link products in the protocols to appropriate levels in the product searching tools. As a result, the protocols enjoy a direct link to e-commerce. Second, the availability of protocols on a website allows for scientists to find a protocol for a new technique or for using a product from a specific supplier.

The protocols embodied in the invention may have links to other areas of the website to provide users with the ability to navigate the site easily and quickly, and to increase the functional value of the protocol through its integration with related data sets. Protocols may be collected from many different sources. The protocols used in the present invention may be obtained from any source, such as publishers and suppliers, that has the required level of editorial review to provide confidence to the user of the validity of the protocol. For example, suppliers who provide their product data for the website may also provide their in-house protocols. The protocols may be specific in nature, outlining the use of a single product, or may describe a general procedure that can be applied to the use of many different products. The invention may also incorporate an in-house database of supplier protocols that allow for easy viewing and comparison. Protocols may also be obtained from publishers of protocol manuals.

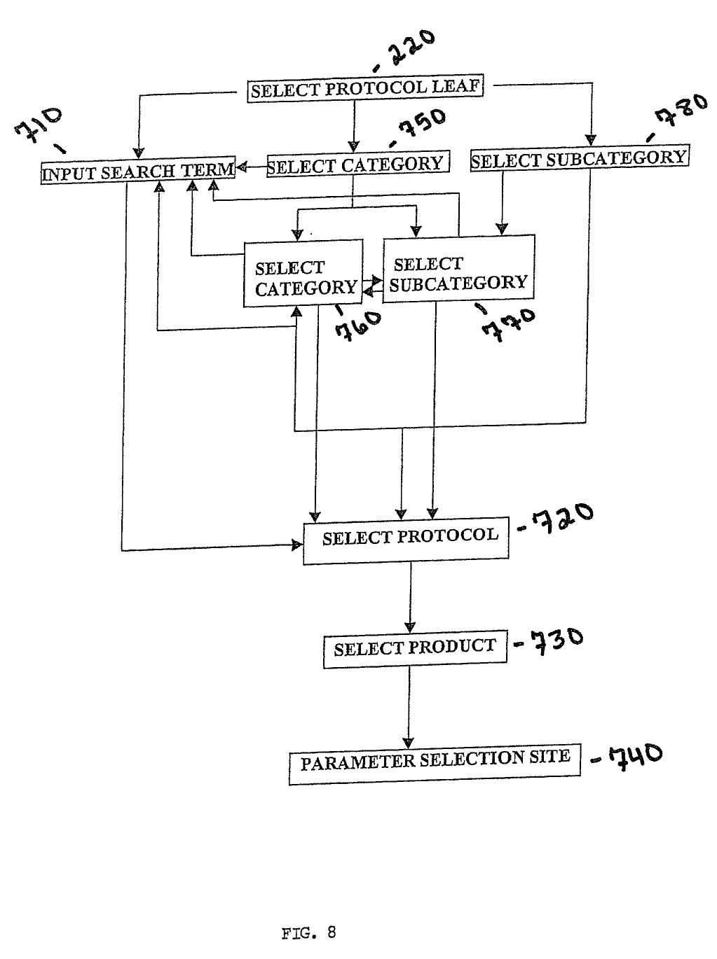

Users are able to find the protocols in at least two ways. First the user may perform a text search. Alternatively, or in addition to the search approach, the user may navigate a logical hierarchy, or ontology, of protocols organized by scientific discipline and by technique. The protocol ontology may be displayed as four major categories (or more, depending on the field) with major subcategory headings also displayed. The subcategory headings are preferably displayed on the same page as the major category headings for ease of navigation, but may also be displayed separately. Layers of subcategories below these are subject to individual variations in fields of experimentation. The user is guided through the ontology by a “bread crumb trail” showing them their path of navigation such that they can rapidly go back one or more levels when navigating the layers of the ontology. FIG. 8 shows a flowchart of the steps a user may take to select a specific protocol from the site.

As shown in FIG. 8, when the user selects the Protocol leaf 220 from Home Page 200, the user can then choose from at least three different options to find a desired product. If the user knows the product or compound name for which a protocol is directed to or includes, the user may input a search term 710. Upon entering a search term, the user may then choose to select a protocol 720. Upon selection of a protocol, the user may then select a product 730. If parameters are available to define the product, the user is then taken to a Parameter Selection Site 740. Upon entering the desired parameters, a list of manufacturers is displayed.

Alternatively, the user may select a category 750 from the Protocol leaf 220. After selecting the category, the user may select another narrower category 760 or a specific subcategory 770. At any point, the user may enter a search term 710 and follow the process outlined above. It is important to note that the search will yield a protocol selection depending at what point, i.e. what level of the category/subcategory hierarchy, the user inputs the search term. In addition, within each category level there may be several categories and subcategories. When further breaking down of categories and subcategories becomes nonintuitive, the user may select a protocol 720. Upon selection of a protocol, the user may then select a product 730 for use in the protocol. Such products may be listed in another frame or in the same frame on the page. If parameters are available to define a product, the user is then taken to a Parameter Selection Site 740. Upon entering the desired parameters, a list of manufacturers is displayed.

The user may also select a subcategory 780 from the main protocol leaf page. Again, the subcategory can be further divided or the user can directly select the protocol 720. Upon selection of a protocol, the user may then select a product 730 for use in the protocol. Such products may be listed in another frame or in the same frame on the page. If parameters are available to define a product, the user is then taken to a Parameter Selection Site 740. Upon entering the desired parameters, a list of manufacturers is displayed. In addition, the user may input a search term at this or any level of the search process.

Protocols are associated with the protocol ontology and their links to the product ontology. Protocols in PDF or XML format can be loaded into a protocol database and associated with a certain level of the protocol ontology in a manner such that they will be found quickly and easily in a search of that branch of the ontology. The protocol integration tool allows protocol editors to append short descriptions to protocol titles and to keep track of the status of the protocol in terms of editing, linking to products and quality control. The tool provides functionalities similar to the ontology and product record creation and management tool. For example, it allows for the creation of categories or leaves of the protocol ontology. It also allows for the assignment of digital protocol records to one or more leaves within the protocol ontology and the addition of information or parameters to digital protocol records for the purposes of organization and searching within the system. It further allows for the assignment of arbitrary relationships between protocol records and any other record (product, protocol, literature, news, tool, or table) within the system. One of the differences between the protocol management tool and the ontology and product record creation and management tool is that the protocol management tool has been tooled for highly efficient management of specific records in specific formats such as a portable document format. However, it can readily be used to manage all arbitrary file types. Protocols can be checked out of the database for editing and for preview for the purpose of linking products from the protocol to the product ontology. Protocols can also be moved from one branch of the ontology to another, if necessary.

The protocol ontology allows the user to narrow their search for a protocol through a logical hierarchy of protocols. The deepest level of the protocol ontology is a “leaf” containing protocols that represent the same type of experimental approach from several different sources. These sources may be organized either as supplier protocols or publisher protocols. The positioning of the supplier protocols may be auctioned to suppliers and the titles for those protocols may contain the logo for the supplier from which they came. Alternatively, or in addition to that positioning, the supplier may be organized alphabetically. Publishers' protocols are preferably displayed by their title and by the publisher source and are preferably organized alphabetically.

At the leaf level, there may be a general or specific list of products that can be used for the general technique. These links will be generated using the protocol tool. These products are in turn linked to parametric search tools within the product ontology and will allow users to utilize the advanced search tools and guide them to create a shopping list. Protocols within a leaf may be classified as detailed or brief and as general or product specific. This will aid users, for example scientists, in their choice of protocol. Protocols may be displayed within a leaf as a list. The positioning within the list may be auctioned off. For example, the top positions may be auctioned to suppliers where the winner of the top position may have a large supplier logo next to their protocols and the next top bidders may have smaller logos. Suppliers who did not win the auction or did not bid may not be allowed to have a logo. As an incentive to bidders, the top supplier may have an additional logo on the page with a sponsorship phrase.

The protocols may be displayed in XML or PDF format in a window that contains protocol-specific and other functionalities. Supplier protocols may be converted to PDF format to preserve their original format. Alternatively, the display will be of individual protocols regardless of their original format. Protocol-specific functionalities include, for example, the list of products mentioned in the protocol, general products for this technique, a list of related protocols, publications (e.g., research articles) and supplier logo. Other functionalities include allowing the user to email the protocol to another individual, save the protocol in a filing system maintained by the website, print out the protocol, access the Tools and Tables section, and navigate the site. Products found in specific protocols can be picked out and listed at the level where a single protocol is shown. This list will be hyperlinked to appropriate areas in the product ontology. These links can be to broad categories or to specific supplier products. In addition, this tool makes it possible to hyperlink each protocol to related protocols on the site. Further, navigation between the protocol section of the site and the product section of the site will retain the protocol product listings so that a user can perform a parametric search on one product, add it to their shopping list, and then go to the next item on the list from the protocol page and perform a search on that or return to the protocol.

Literature

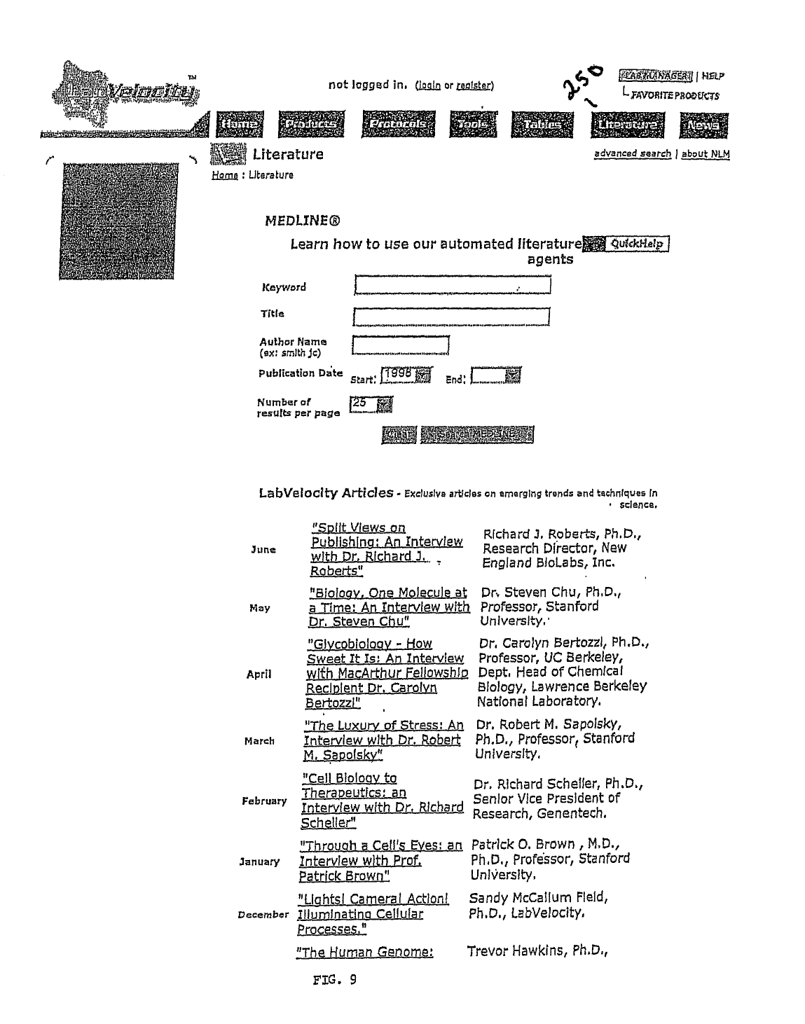

Another embodiment of the invention provides for a global navigation system for the literature leaf of the invention. FIG. 9 shows an example of the display on computer 100 when the user selects Literature leaf 250. This system is similar to that of the other parts of the site. The search page allows the user to use a database for literature searches, for example, the Medline database. The interface may contain fields common to other literature database searches throughout the Internet, for example, keyword, author and title. The user is preferably given the option to search with as many or few of the fields they wish. In addition, the page preferably contains answers to frequently asked questions about literature searches.

In addition to the general search, another embodiment of the invention allows the user to perform an advanced search containing additional fields. Such fields include, for example, specific databases to search, journal name, date range, authors affiliation, and a restriction on review articles.

The search result page gives the user the ability to view results chronologically or by confidence. Links from the results may be to abstracts or a full-text of the article. Preferably the information from the database is in XML format.

Another embodiment of the invention is the ability for the user to create a searching agent. Any search can be saved as an agent whose results may be displayed on the registered user's homepage. Users may run several separate agents simultaneously. For example, the user may run four or even five separate agents simultaneously. The agent based searches can include the same search parameters as regular literature searches, including keywords, authors, and title words. Users may also have the option of receiving an email of the agent search results on a periodic basis, for example, daily, weekly, or monthly. If a user has multiple active agents, the agent results may be sent separately or may be compiled into a single email. The searches may also be saved in the user's file folder on the website. In addition, the user is able to filter search results. In other words, the user is able to go through the list and check articles of interest and then save these results in the user's file folder. The user may then go to an advanced search page with the correct fields already filled.

In addition, the invention comprises an article detail page that contains all of the information about the article from the database. This information can be saved in a folder, printed, or emailed to another person. Moreover, users are able to link to many full-text articles from the abstract page. These articles may be freely available or available through a license or other relationship with the host. Preferably, the content of the articles may be linked to within the context of a frame. This frame may contain an advertisement, a button to save or print the article, and/or a link to the journal's homepage. This service is preferably linked to other parts of the site and is integrated within a complete resource site.

Lab Manager

Another aspect of the invention is the “lab manager.” This feature allows users to save, store and manage and modify records, as well as gives users the ability to organize the areas of the site to which they frequently refer. The lab manager also allows users to store references or records to different pages of the site. For example, the user can save, store and manage literature, products, protocols, shopping lists, and Tools and Tables sections in the lab manager. The lab manager may include default prenamed folders of the different pages in the site, and custom user defined folders. Users are also able to create and delete folders and/or rename the existing folders. Users may name the file or accept the name suggested by the lab manager.

Tools and Tables

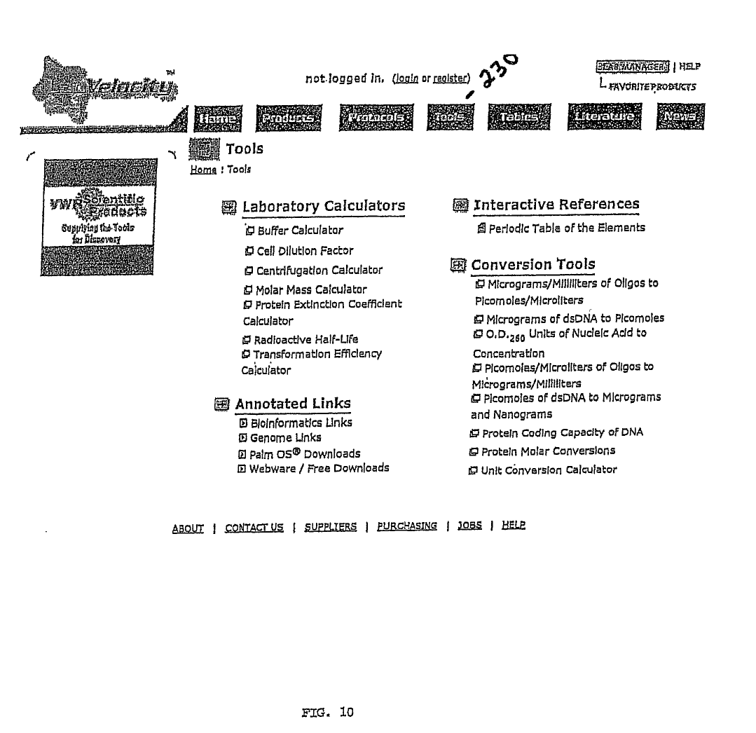

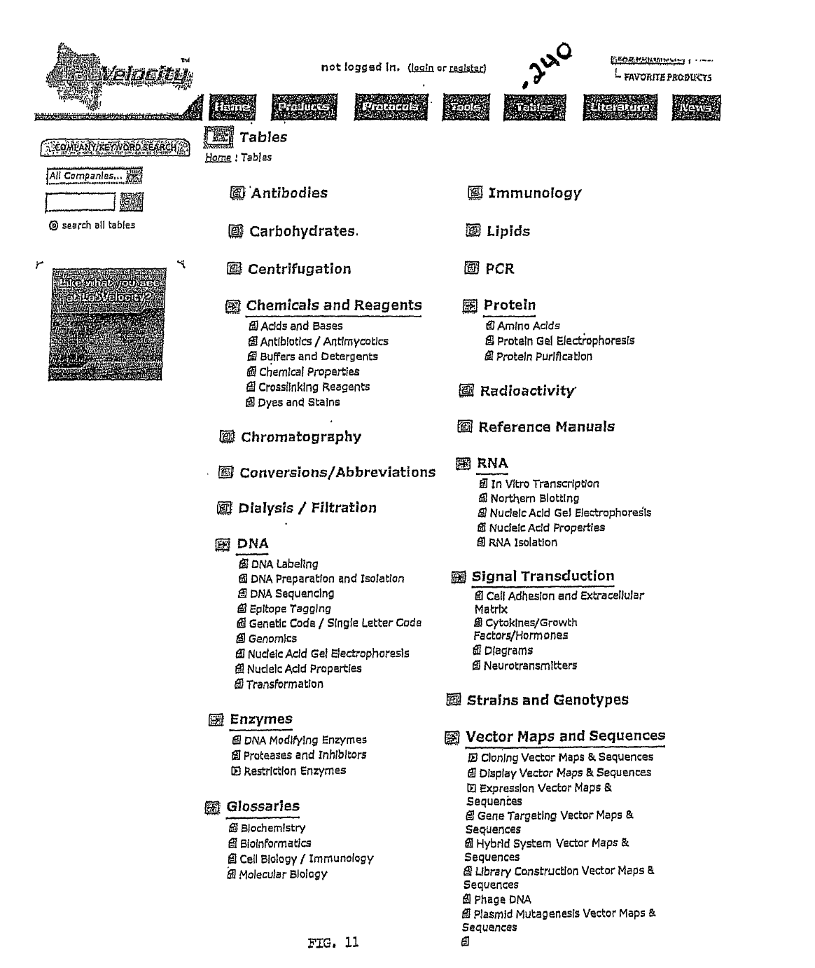

Yet another embodiment of the invention includes the Tools and Tables leaves. These aspects enables researchers to rapidly access supplemental information important for daily research. FIG. 10 shows an example of the display on computer 100 when the user selects Tools leaf 230. FIG. 11 shows an example of the display on computer 100 when the user selects Tables leaf 240. Examples of such information include a collection of both in-house and supplier-provided summaries, biochemical pathway diagrams, conversion tables, and other sources of commonly used, field-specific scientific information. This information may be provided in HTML or PDF format. The information may be organized into a logical hierarchy based on categories of content defined by individuals with domain specific knowledge.

The Tools and Tables management tools provide functionalities similar to the ontology and product record creation and management tool in that it allows for the creation of leaves or categories of the Tools and Tables ontologies; assignment of records of diverse file types to one or more leaves within the Tools and Tables ontologies; addition of information to these records for the purpose of organization and to enable searching within the system; and assignment of arbitrary relationships between Tools and Tables records and any other record (product, protocol, literature, news, tool, or table) within the system. One of the differences between the Tools and Tables management tools and the ontology and product record creation and management tool is that the former set has been tooled for highly efficient management of specific records in specific formats such as a portable document format, although it can readily be used to manage all arbitrary file types. These tools include logic with a specialized interface designed for the management of records classified as Tools and Tables within the system.

Interactive calculators easily accessible from the site may be used in conjunction with this information. In addition to the calculators, the page preferably contains conversion tools to automatically perform common laboratory conversions. Other examples of useful tools that may be included are a buffer calculator that is used for obtaining recipes for common laboratory buffer solutions. Including links to other publicly available information, such as Bioinformatics Resources, allows users to find the appropriate tools needed for other analyses or operations. Moreover, the user can click onto related protocols, other tools and appendices needed for other analysis or operations, on the same page.

News Services

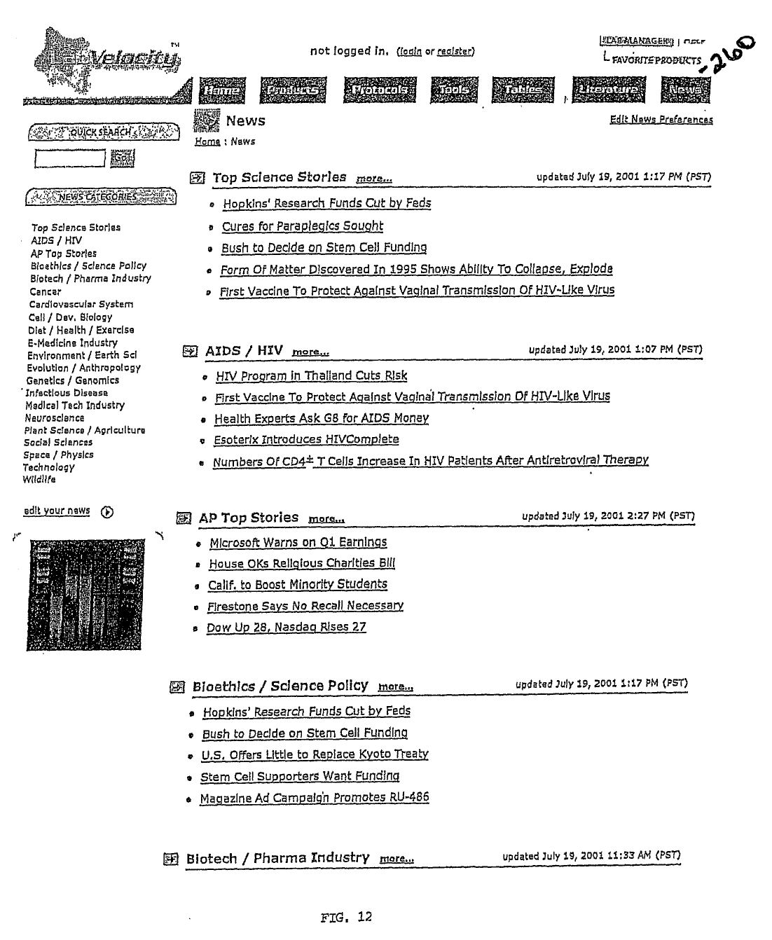

Another aspect of the invention is means for keeping the users informed of field-related news. FIG. 12 shows an example of the display on computer 100 when the user selects News leaf 260. For example, in the life sciences arena, the news page would be primarily directed towards science and health-related news to keep the user abreast of timely developments. News articles may be archived but considering the short shelf life of a news article, such archiving tools as used in other sections of the system are not necessary. News articles may be organized into editorially defined channels in addition to being subject to keyword-based search agents and/or spontaneous keyword searches. One or more news source consolidators may be used to provide access to feeds from several sources. These articles are preferably in XML format and may be updated periodically and may be stored for later retrieval.

The news management tool is an application that recognizes and facilitates the organization and management of digital records, such as text-based news articles, in a queue, and the creation of a management or organization structure for these records. This application provides functionalities to create or modify a listing structure, such as a group of categories for news articles, for digital records in a queue; access, read, categorize or delete records to or from categories or channels within a created listing structure for management, searching and display of records; and automate manipulation of deletion of records.

Subject areas in the life sciences fields include but are not limited to, for example, scientifically related subjects such as new discoveries, health care, biotech news, science policy, announcements and meeting schedules, and general scientific news from a selection of news sources. The service may be customized to the user. By initiating keywords search agents, researchers may be able to focus on the news stories and scientific articles that are relevant to their designated fields. These searches provide continuously updated articles and allow users to stay current on the breaking news in their fields in a minimum amount of time.

The news articles may be incorporated onto the site using an administration tool to place articles in proper channels. This administration tool is able to bring articles from outside sources into a staging area. From there, the news editor may eliminate duplicates and irrelevant articles, and categorizes the remaining articles into groups. The number of groups may vary on the field and categories chosen. Once it is categorized, an article may be displayed on the web site in its assigned channels. The news page preferably contains the headings of all the news channels with a subset of article headlines that link to the full article. The user also has the option of customizing its news group or link to a page highlighting one or more news groups. The page highlighting a channel of news contains headlines of the articles in that category as well as some article detail. The news articles are assigned to as many categories as are relevant. The article detail may contain any information specific to that article, for example, publication name, date, title, byline and the text. The page may also contain section specific navigation such as access to customization area, access to other news channels, automatic channels and email.

The news button of the home page preferably contains a link to the general news page and to a user registration and customization page. On the general news page, the user is able to find articles grouped by topic. Users may also have several functional options. For example, a user may be able to click on a headline to get the full story, click on a category to be taken to a list of all the headlines in that category, and submit a keyword search and be taken to a list of matching articles.

The user is also able to register for a personalized home page. On the home page, there is preferably a choice of channels that the user has the option of choosing in addition to a saved keyword search. The news categories and saved keyword search may further be included in the personalization choices in addition to the literature search agent and the database search agent. Moreover, there may also be included a link to create a news keyword agent. This feature allows the user to store a keyword of interest. For example, when the user goes to the home page, any new relevant articles will be displayed as a customized channel. Functions in the main news page may also be present in the personalized news page. In addition, if an article is assigned to multiple channels, it will only appear in the first subscribed channel on a user's homepage.

Users may also search the news page by entering a query. Any applicable articles will then be displayed in a systematic manner, for example, chronological order. Other options include sorting by date and confidence. Each hit may also display the article's title and other pertinent information. Similarly, users may click to a news page that contains only the user's subscribed channels.

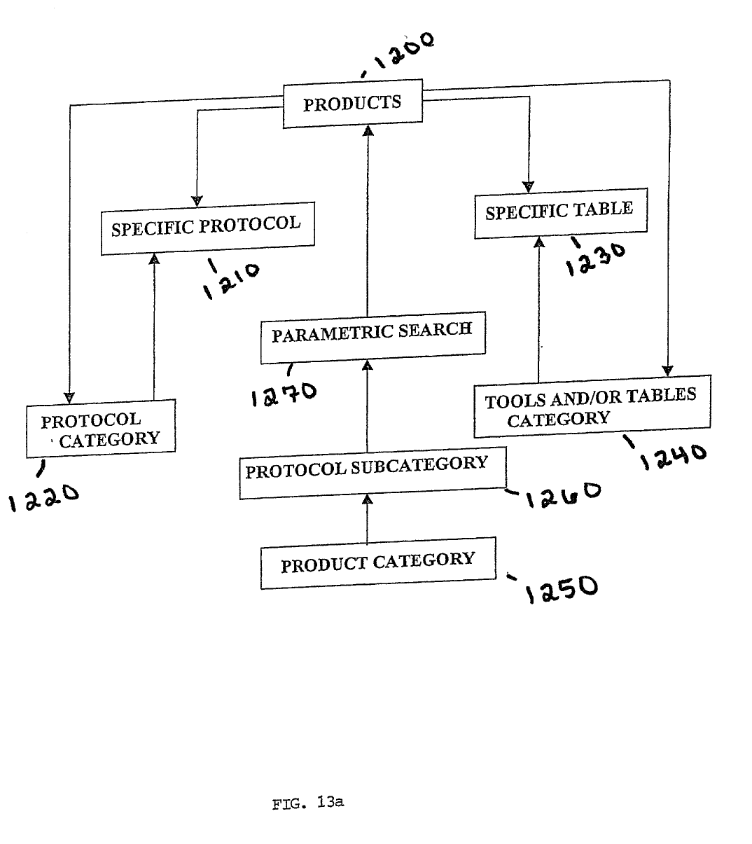

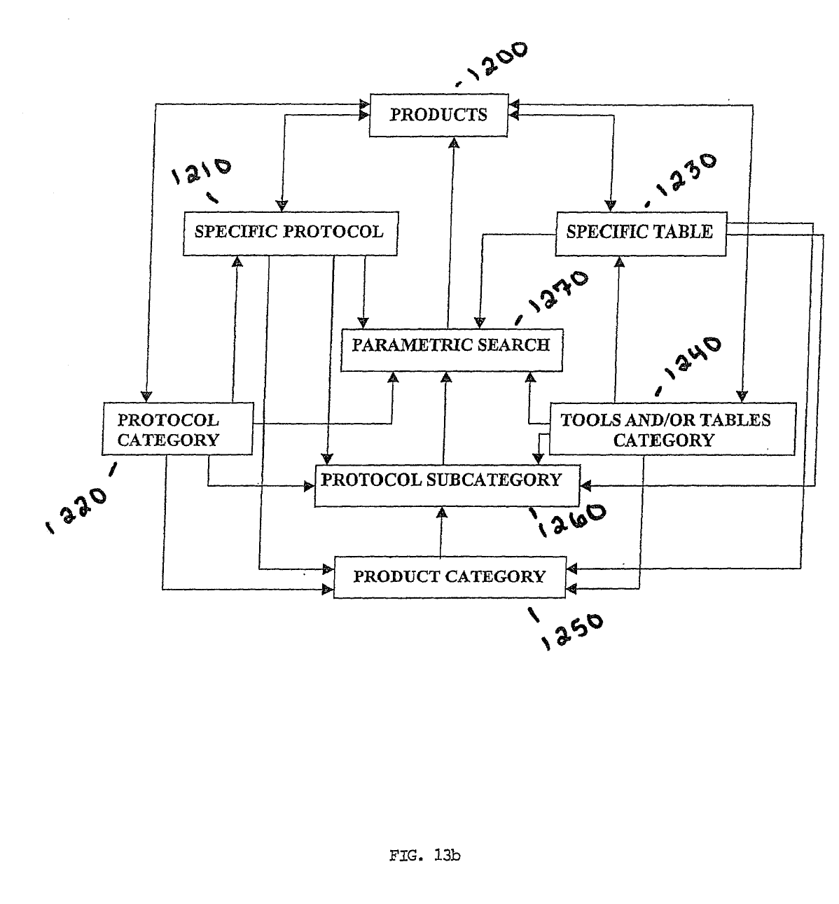

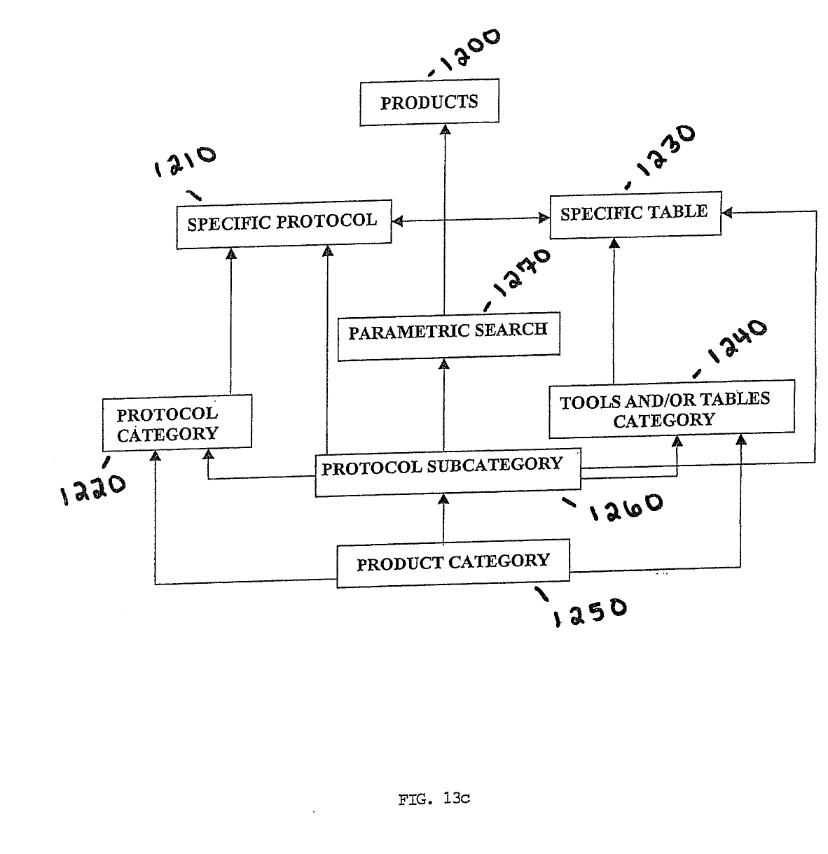

Through these various levels, the invention provides a positioning of a system for hierarchical organization over many parametric search tools and integrating this system with the resources, tools, literature, and products in the field. FIGS. 13a-c provides flowcharts for examples of the integration between levels. FIG. 13a shows an integration diagram linking Products to Protocols and Tools and Tables. Specifically, FIG. 13a shows how a user can go from a product 1200 to a specific protocol 1210, a protocol category 1220, a specific table 1230, or to the tools and/or tables category 1240. In addition, FIG. 13a shows how a user can go from a product category 1250 to a protocol subcategory 1260 to a parametric search 1270 to yield a desired product 1200. FIG. 13b shows an integration diagram linking Protocols and Tools and Tables to Products.

Specifically, FIG. 13b shows the same links as FIG. 13a but illustrates the depth of integration between the levels. For example, a user can reach products 1200 from protocol category 1220, specific protocol 1210, specific table 1230, and tools and/or tables category 1240. In addition, the user can go from protocol category 1220 to a specific protocol 1210, a parametric search 1270, a protocol subcategory 1260, and a product category 1250. The user can also go from the specific table 1230 to a parametric search 1270, to a protocol subcategory 1260, or to a product category 1250. The user can go from the tools and/or tables category 1240 to a specific table 1230, to a parametric search 1270, to a protocol subcategory 1260, and to a product category 1250. FIG. 13c shows an integration diagram linking Protocols and Tools and Tables. Specifically, FIG. 13c illustrates how the user can go from the products category 1250 to a protocol category 1220, a protocol subcategory 1260, and to a tools and/or tables category 1240. In addition, the user can go from the protocol subcategory 1260 to a protocol category 1220, a parametric search 1270, a specific protocol 1210, a specific table 1230, and to a tools and/or tables category 1240. The user can also go from a tools and/or tables category 1240 to a specific table 1230 and from a protocol category 1220 to a specific protocol 1210. In addition, the user can go back and forth between specific protocol 1210 and a specific table 1230. The user can also go from the parametric search 1270 to the products 1200.

The relationship/association creation and management tool, which was developed for this system, provides functionalities for creating a class or classes of arbitrary relationships or associations between digital records. For example, a class of relationships may, for example, be a relationship or set of relationships between one or many product records and one or many protocol records. This tool is used to define these relationships and the rules that govern these relationships, while other tools (as described above) are used to define relationships between specific records within a single class of digital records or between multiple classes of records. The business unit management tool provides functionalities to add or remove digital records to specific classes or organizations of records that are defined as business records (i.e., those not defined as products, protocols, literature, news, tools or tables). For example, this application may be used to manage records containing information on manufacturers of products.

The invention may also be used in conjunction with a capital equipment and instrumentation and used in conjunction with a parametric showroom and online locator. For example, the invention may be used with an e-commerce model that allows unrealized online aggregation of laboratory capital equipment and instrumentation. Such a model may be predicated on the inventive search techniques. This would allow for the selection of laboratory and research goods and services via the hierarchical and parametric classification provided by the invention. In an embodiment of the invention that includes capital equipment and instrumentation, the system logic would include an electronic broadcast referral to one or more client-defined suppliers through various modalities. The broadcast referral may provide suppliers of capital goods with details specifying the client's purchasing expectations, requested services, contact information, and any other relevant information. The recipient supplier would respond to the client's stated preferences and begin the procurement process. Though the above-described model focuses on laboratory capital equipment and instrumentation, it can be applied more generally across any market in which capital goods and/or contract services are sold. The model provides for simultaneous contact and transmission of buyer preferences to an unlimited number of suppliers. This allows the buyer to save time, energy and frustration by not having to investigate individual suppliers through catalogs, websites, phone calls, and/or appointments. It further facilitates management of the relationship between buyers and suppliers of capital equipment through a Quote Management System. The equipment search is further streamlined by the inventive hierarchically structured database and parametric search tools.

The invention may also include educational and reference materials, as well as tabulated comparative data and “showroom” graphics. Thus, the database may optionally include additional purchasing resources such as equipment reviews, articles relating to capital equipment, maintenance and troubleshooting, a searchable reference database of literature where equipment had been used, promotions, workshops and seminars, and an e-Classifieds portal for used, refurbished, or discontinued laboratory equipment, instrumentation and suppliers.

All of these products may be included in the products ontology. Similar to the chemical reagents, the system includes logic to classify laboratory equipment and instrumentation based upon scientific disciplines, techniques, and methodologies. For example, the site for new equipment and instrument locator can be accessed via Product leaf 210. This site can also feature links to categories and graphics advertising featured products. The graphics can be further linked to featured instruments' specifications and supplier advertising. Other links could include instrument review, featured articles, sales and promotions, new product announcements, workshops and seminars, and used equipment classifieds. Further, the site can be integrated with the literature, news, tools, tables and protocols sites. The site can also contain an instrument reference search tool that accesses supplier-contributed reference materials and active links to specific items.

As with the other products, each equipment category ends with a page containing selectable parameters specific to that class of instruments. The user then inputs the parameters and the selection is communicated to an analysis program. The program then provides a list of products consistent with the specified parameters, which list is displayed on computer 100. Further, the user can select products to be compared in a table. Such table can compare products from multiple suppliers.

The invention optionally includes options for users to directly contact a limited or unlimited number of suppliers through a web-based interface. For example, the user may input instrument specifications to be sent to suppliers of their choice. User information may be automatically or manually entered into referral requests and transmitted to suppliers via electronic or traditional means. The invention optionally includes resources for assisting in the purchasing process. Such resources include, but are not limited to, instrument/equipment reviews, reference materials relating to capital equipment, maintenance and troubleshooting, a database of research literature that references specified equipment, promotions, workshops and seminars. Further, the system may facilitate the capture and analysis of market information. This information may be delivered to suppliers, participating or nonparticipating, for no charge or payment.

In addition to the locator and referral services relating to new capital equipment and instruments, the site may also offer opportunities to buy and sell used, refurbished, or discontinued equipment, instruments, and supplies. This system could be customized client-server software or use a GUI web-based template. The system may also be set up so that browsing or posting the ads may or may not be charged to users.

The inventive model employs, as its foundation, software that allows for the real-time posting and viewing of classified advertisements offering the sale or used, reconditioned, and discontinued equipment and instrumentation. The web-based server hosting the electronic classifieds forum plays an important role in the electronic mediation of the sales transaction by offering a number of value-added services. Such services include, but are not limited to, the creation and management of an international community forum through which buyers and sellers can network in real-time to effect the trade or purchase of used, reconditioned, or discontinued laboratory equipment and instrumentation; profiles of sellers and buyers, as developed through mined site data of buying and selling histories; access and referral to third-party escrow services; access and referral to professional packaging and shipping services; and in cases where not offered by the seller, a built-in limited warranty on all used, reconditioned and discontinued instruments and equipment purchased through the classifieds forum. The program can either be a customized cgi script or off-the-shelf software (e.g., e-classifieds), both of which would allow for the real-time posting and viewing of classified advertisements.

One embodiment of this invention includes a common navigational link to the e-classifieds for both buyers and sellers of used, reconditioned, and discontinued laboratory equipment and instrumentation. Other links for viewing, posting, registration, profile and account management, as well as search and filter functions for locating desired items may also be included. FAQs, service provides, terms of agreement, links to instrument and equipment reviews and new product listings are also preferred.

The seller can maintain a password-protected account management database to view current and past listing; to add, delete or modify current listings; to view fees owed; and to create or modify account and profile information. Other services available to the seller include real-time posting of item or items to be sold, including customized fields for accurate description of item(s), as well as the ability to upload graphics displaying said item or items; and direct electronic access to relevant service providers, including but not limited to escrow services, shipping and packing services, warranty services and/or service contracts.

The buyer can also maintain a password-protected account management database to view current and past listing; to add, delete or modify current listings; to view fees owed; and to create or modify account and profile information. Other services available to the seller include real-time posting of item or items sought, including customized fields for accurate description of item(s); and direct electronic access to relevant service providers, including but not limited to escrow services, shipping and packing services, warranty services and/or service contracts. Moreover, buyer services optionally include automated email communications with a listed buyer, as indicated via a hyperlink in the seller's listing.

The server captures, stores, and relays all listings and communications between buyers, sellers, the system and third-party service providers (e.g., escrow services, shipping and packing services, warranty services, and/or service contracts).

What is claimed is:

1. A method for obtaining a list of products having specified parameters; comprising:
inputting a product or compound name;
determining one or more uses of the product or compound and displaying a list of such use or uses;
selecting a use of the product;
generating a parameter selection site based on the selected use;
inputting parameters;
generating a list of products that meet the selected parameters.
